(19) United States
(12) Patent Application Publication
(10) Pub. No.: US 2018/0040926 A1
(43) Pub. Date: Feb. 8, 2018

(54) INDIRECT BATTERY PRESSURE MEASUREMENT

(71) Applicant: Infineon Technologies AG, Neubiberg (DE)

(72) Inventors: Goran Keser, Munich (DE); Christopher Roemmelmayer, Munich (DE); Daniel Gernert, Taufkirchen (DE)

(21) Appl. No.: 15/229,953

(22) Filed: Aug. 5, 2016

(51) Int. Cl. H01M 10/48; G01L 9/00; H01M 10/0525; H01M 10/42; H01M 2/14; H01M 10/04

(52) U.S. Cl. CPC H01M 10/48; H01M 2/14; H01M 10/0413; H01M 10/0436; H01M 10/0525; H01M 10/4285; H01M 10/425; G01L 9/0041; H01M 10/486; H01M 2200/20; H01M 2200/10

(57) ABSTRACT

Embodiments described herein relate to a battery cells and methods for measuring internal pressure in a battery cell. According to one embodiment, a battery cell includes an interior space, in which a battery electrolyte resides, and a housing that gas-tightly encloses the interior space. The battery cell further includes a gas-tight sealed measurement chamber, which is separated from the interior space by a deformable membrane, in which a pressure sensor is arranged.

### TECHNICAL FIELD

Embodiments described herein relate to the field of battery technology, in particular to the measurement of the internal pressure of a battery cell.

### BACKGROUND

Batteries are used in a large variety of applications. For example, in electric vehicles lithium-ion batteries are used, which include a large number of battery cells. When a battery cell is loaded with a current (e.g. during charging and discharging cycles) the internal pressure of the battery cell changes. During use of a battery the internal pressure in the battery cells may vary as the number of charging/discharging cycles increases. Aging may also lead to an increase of internal pressure of the battery cell. An excess pressure may destroy the battery cell. Therefore, modern battery cells are usually equipped with various safety mechanisms that may prevent destruction of the battery cells. Those safety mechanisms usually are aim at a controlled pressure release by a specific design of the cell housing, which may include pressure relieve valves, tearable membranes or the like. Furthermore, so-called circuit interrupt devices (CIDs) may be provided, which mechanically interrupt the load current flow through the battery cell in case of an excess pressure.

In order to be able to detect a critical state of a battery cell, it may be desirable to obtain information of the internal pressure of the battery cell. The internal pressure of a battery cell may be indicative of the State of Health (SOH) and the State of Charge (SOC) of the battery cell. Thus, information about the internal pressure may be used for battery management.

### SUMMARY

A battery cell with pressure measurement capability is described herein. In accordance with one embodiment, the battery cell includes an interior space, in which a battery electrolyte resides, and a housing that gas-tightly encloses the interior space. The battery cell further includes a gas-tight sealed measurement chamber, which is separated from the interior space by a deformable membrane, in which a pressure sensor is arranged.

Furthermore, a method for measuring internal pressure in an interior space of a battery cell, in which a battery electrolyte resides, is described herein. In accordance to one embodiment the method includes measuring pressure of a gas-atmosphere enclosed in a measurement chamber, wherein the measurement chamber is separated from the interior space of the battery cell by a deformable membrane.

### BRIEF DESCRIPTION OF THE DRAWINGS

The invention can be better understood with reference to the following description and drawings. The components in the figures are not necessarily to scale, emphasis instead being placed upon illustrating the principles of the invention. Moreover, in the figures, like reference numerals designate corresponding parts. In the drawings:

FIG. 1 is a schematic illustration of an exemplary battery cell.

FIG. 2A and FIG. 2B are a front view and a top view respectively of an exemplary battery cell including a tearable membrane as a safety feature; the membrane ruptures at a defined internal pressure of the battery cell thus allowing for a controlled pressure release.

FIG. 3 is a diagram illustrating one example of the variation of the internal pressure of a battery cell throughout several charging/discharging cycles.

FIG. 4A and FIG. 4B are a front view and a tope view respectively of one example of a battery cell having a pressure sensor arranged within a measurement chamber separated from the interior of the battery cell by a membrane.

FIG. 5 is a diagram illustrating the relation between change of the volume in the measurement chamber (due to bulging of the membrane) and internal pressure of the battery cell.

FIG. 6A and FIG. 6B are front and top views respectively of a further example of a battery cell having a pressure sensor arranged on a PCB within a measurement chamber.

FIG. 7 is another example of a battery cell having a pressure sensor arranged in a gas tight measurement chamber.

FIG. 8 is another example of a battery cell having a pressure sensor arranged in a gas tight measurement chamber as well as a temperature sensor.

FIG. 9 is a flow chart illustrating one exemplary method for measuring internal pressure of a battery cell.

### DETAILED DESCRIPTION

Although the term “battery” is a common term to describe an electrochemical storage system, international industry standards differentiate between a “battery cell” (or simply “cell”) and a “battery”. A battery cell is a basic electrochemical unit that includes the basic components, such as electrodes, separator diaphragm or simply separator, and electrolyte. FIG. 1 is a schematic illustration of a battery cell 1, for example a lithium-ion cell, wherein the positive electrode (cathode while discharging) labelled 13, the negative electrode (anode while discharging) is labelled 14, the electrolyte included in the cell 1 is labelled 11 and the separator is labelled 12. In the example of a lithium-ion cell, one cell is a cylindrical, prismatic or pouch unit that provides an average potential difference at its terminals between three and four volts, dependent on the electrode materials and the electrolyte used in the cell. The negative electrodes may include, for example LiCoO₂, LiFePO₄, LiNiO₂ or LiMn₂O₄, while the positive electrode usually includes graphite or copper. The electrolyte usually include lithium salts such as such as LiPF₆, LiBF₄ or LiClO₄ in an organic solvent, such as ethylene carbonate, dimethyl carbonate, and diethyl carbonate. The construction and the electro-chemistry of batteries and particularly lithium-ion batteries are as such known and thus not further explained herein.

If overheated or overcharged, lithium-ion batteries may suffer thermal runaway and cell rupture. In extreme cases this can lead to an explosion. To reduce these risks, lithium-ion battery packs may include fail-safe circuitry that disconnects the battery cells when its voltage is outside a safe range of, for example, 3.0 to 4.2 V per cell. Lithium-ion cells may be very susceptible to degradation or damage when operated outside the specified voltage range, that is above a maximum voltage or below a minimum voltage. Exceeding this voltage range may results in premature aging of the cells and, furthermore, results in safety risks due to chemical reactions in the cells, which may, inter alia, lead to an increased internal pressure. For common lithium-ion cells (e.g., nominal voltage 3.6 V, cutoff voltage 3.0 V) the minimum voltage may be, e.g., 2.7 V, while the maximum voltage may be 3.7 V.

In addition to extreme conditions like over-heating and over-charging, the internal pressure of a battery cell (e.g. a lithium-ion battery cell) may increase when the battery cell is loaded with a current (e.g. during charging and discharging cycles) or as a result of aging. Thus, the internal pressure in the battery cells may vary as the number of charging/discharging cycles increases during use of the battery. An excess pressure may destroy the battery cell, which may in the worst case lead to the battery catching fire or even to an explosion. However, modern battery cells are usually equipped with safety mechanisms that prevents an over-pressurized battery housing. As mentioned, those safety mechanisms may aim at a controlled pressure release by a specific design of the cell housing (e.g. by providing pressure relieve valves or tearable membranes in the wall of the housing). Additionally CIDs may be used to mechanically interrupt the load current flow through the battery cell in case of an excess pressure. However, such CIDs contribute to increased internal resistance of the battery.

One safety mechanism, for example, may include a tearable membrane arranged in the wall of the housing of the battery cell. The housing and the membrane are gas-tight so that the membrane deforms as the internal pressure increases. The membrane is designed to rupture (tear-away) when the internal pressure exceeds a defined limit and are therefore also referred to as “tear-away tab”. Thus, the membrane allows a controlled pressure release once the internal pressure of the battery cell reaches a dangerous level. The walls of the cell housing are rigid as compared to the membrane, so that essentially only the membrane is deformed in case of an excess pressure in the interior of the battery cell. The controlled pressure release may avoid a dangerous explosion. This example is illustrated in FIG. 2a and FIG. 2b, wherein FIG. 2a is a front view and FIG. 2b is a corresponding top view. FIG. 2a and FIG. 2b illustrates a battery cell 1 with a rigid cell housing 10 and the positive (+) and negative (−) terminals 15, 16 arranged on the top surface of the housing. It should be noted, however, that any other geometry or set-up of the battery cell may also be applicable. The electrodes and the separator have been omitted to keep the illustration simple. FIG. 2a and FIG. 2b also illustrate a (elastically and plastically) deformable membrane 17 arranged in one side of the housing 10. The internal pressure in the gas-tight sealed housing 10 is denoted as p_{BAT}.

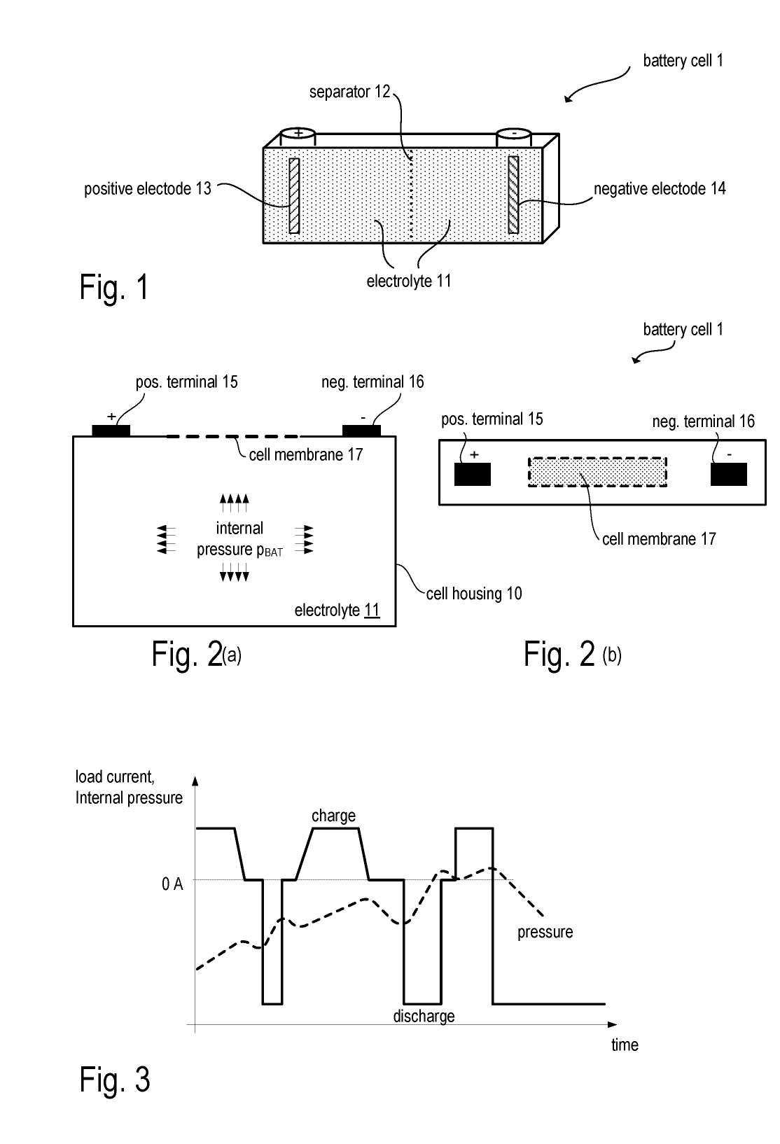

FIG. 3 illustrates in a timing diagram the mentioned variation of the internal pressure in the interior of a cell housing 10 throughout subsequent charging/discharging cycles. A positive load current indicated charging of the battery cell wherein a negative load current indicates discharging.

It may be desirable, however, to detect a critical state of a battery cell before an excess pressure leads to a rupture (or tear-away) of the membrane. For this purpose a pressure sensor may be arranged in the battery cell. The pressure sensor may be configured to sense the internal pressure in the interior of the battery cell and provide the measured pressure information to a controller, which may initiate, based on the measured pressure information, precautions to avoid a further increase of internal pressure. However, it has been observed that the chemicals (i.e. the electrolytes) in the battery cell give rise to corrosion of the integrated pressure sensor, which may degrade and eventually destroy the pressure sensor. Furthermore, integration of the pressure sensor in the interior of the battery cell may cause cracks and leakage particularly at higher pressures.

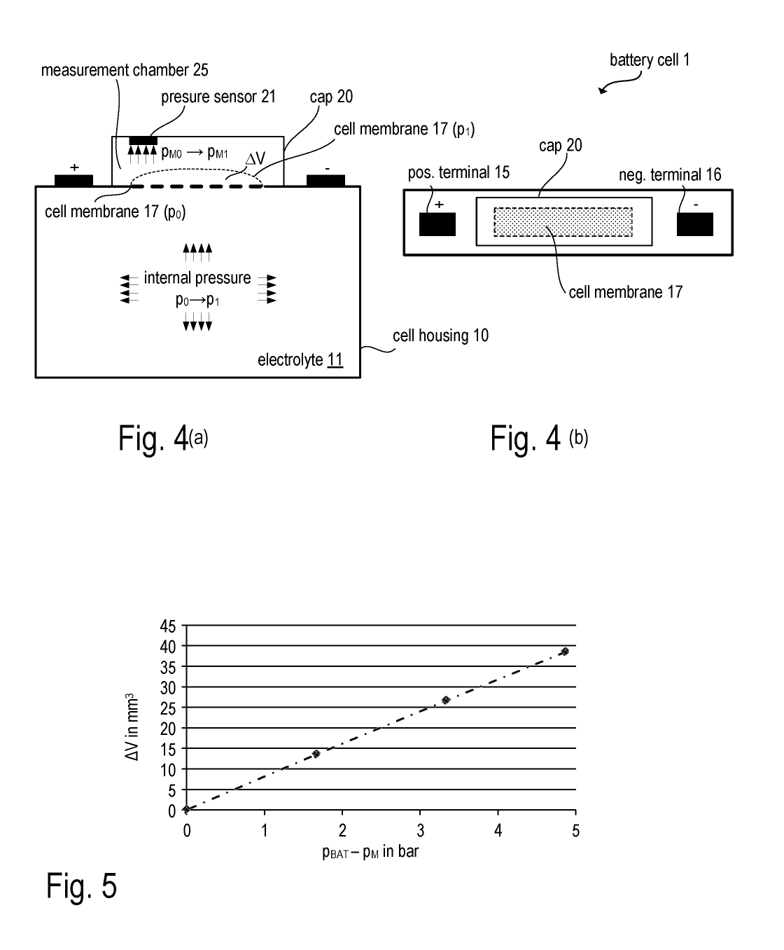

FIGS. 4a and 4b illustrate one example of a battery cell 1 having a pressure sensor 21, which is arranged within a measurement chamber that is arranged in or at the housing 10 of the battery cell 1, but separated from the interior of the battery cell by a (elastically and plastically) deformable membrane 17. The “interior” of the battery cell 1 thereby refers to that space, in which the electrolyte is located and which is gas-tight sealed from its surroundings (and from the measurement chamber) by the housing 10 and the membrane 17. Similar to FIGS. 2a and 2b, FIG. 4a is a front view and FIG. 4b a corresponding top view. In the present example, a measurement chamber 25 is formed by a cap 20 attached to the housing 10 of the battery cell 1. In the present example, the membrane 17 and cap 20 (and thus the measurement chamber 25) are arranged between the positive terminal 15 and the negative terminal 16. However, the membrane 17 may be formed in any other location in or at the housing 10 of the battery cell, wherein the membrane 17 is arranged such that it separates the atmosphere in the measurement chamber 25 (e.g. air) from the interior of the battery cell 1, in which the electrolyte 11 resides.

As indicated in FIGS. 4a and 4b, the membrane bulges into the measurement chamber 25 when the internal pressure in the interior of the battery cell 1 increases. For example, the volume V_{M} available in the measurement chamber 25 is reduced by a differential volume ΔV as the pressure p_{BAT} in the interior of the battery cell 1 rises from initially p₀ to p₁. Since the measurement chamber 25 is also gas-tight, the reduction of volume by ΔV entails an increase in barometric pressure p_{M} from p_{M0} to p_{M1} within the measurement chamber. In other words, the membrane 17 “transforms” a pressure change (e.g. from p₀ to p₁) of the internal pressure in the interior of the battery cell 1 into a corresponding pressure change (e.g. from p₀ to p₁) in the measurement chamber 25.

The mentioned volume change ΔV of the volume V_{M} in the measurement chamber 25 may be analytically calculated using the ideal gas law. Accordingly, the product p_{M}·V_{M} of (absolute) pressure p_{M} and volume V_{M} equals m·R_{S}·T, which is constant if temperature T and the mass of the gas are constant (R_{S} is the specific gas constant), that is

p_{M}·V_{M}=m·R_{S}·T. (1)

When the volume of the measurement chamber decreases by ΔV from V_{M0} to V_{M1}, the pressure in the measurement chamber will increase from p_{M0} to p_{M1}. However, the product

p_{M0}·V_{M0}=p_{M1}·V_{M1} (2)

will remain constant (temperature changes are disregarded in the current analysis). Substituting

V_{M1}=V_{M0}−ΔV (3)

in the above equation 2 yields:

$$\begin{matrix}{p}_{M 1} = \frac{{p}_{M 0}}{1 - \frac{Δ V}{{V}_{M 0}}} , and & ( 4 ) \\ Δ V = {V}_{M 0} ( 1 - \frac{{p}_{M 0}}{{p}_{M 1}} ) . & ( 5 )\end{matrix}$$

The differential volume ΔV essentially depends (i.e. is a function of) on the pressure difference p_{BAT}−p_{M1} between the interior of the battery cell (pressure p_{BAT}) and the measurement chamber (pressure p_{M1}) and the mechanical properties of the membrane, i.e.

ΔV=f(p_{BAT}−p_{M1}). (6)

One can see from equations (5) and (6) that there is a direct relationship between the internal pressure p_{BAT} in the battery cell and the measured pressure p_{M1} in the measurement chamber. That is, the differential volume ΔV depends on internal pressure p_{BAT}, and the pressure p_{M1} in the measurement chamber depends on the differential volume ΔV (wherein p_{M0} and V_{M0} are known constant parameters). The initial pressure p_{M0} in the measurement chamber may be equal to, lower than, or greater than the ambient atmospheric pressure.

Various materials may be used to form the membrane 17 (see FIG. 4a and FIG. 4b) dependent on the application. In the present example, an aluminum membrane has been used. FIG. 5 illustrates one exemplary relation between change of the volume in the measurement chamber (due to bulging of the membrane) and internal pressure of the battery cell. The relation of FIG. 5 has been obtained by simulation of a specific test device, which was used in a feasibility study. For determining the internal pressure p_{BAT} in the interior of the battery cell the pressure p_{M1} in the measurement chamber is measured. Based on the measured pressure p_{M1} the internal pressure p_{BAT} can be determined either using a mathematical model (e.g. see equations 1-6) or using stored characteristic curves (e.g. a look-up table). When an excess pressure is detected, one or more safety mechanisms may be triggered such as, for example, interrupting the load current flow through the battery cell. Accordingly, a separate mechanical CID is not needed.

The pressure sensor may be an integrated barometric pressure sensor, which may be mounted on a printed circuit board such as, for example, Infineon's DS310 digital barometric pressure sensor chip which includes a capacitive sensor element and a digital serial interface. However, many other types of pressure sensors may also be applicable. By appropriately de-signing the nominal volume V_{M0} of the measurement chamber and the geometry (particularly the thickness) of the membrane the available measurement range of the pressure sensor may be adjusted to the desired measurement range of internal pressure of the battery cell. The specific shape of the bulging membrane does not have any substantial influence on the pressure measurement as only the differential volume (caused by the bulging of the membrane) is responsible for a pressure change in the measurement chamber. This may be an advantage as compared to a direct measurement of the bulging of the membrane, which may be accomplished, for example, using capacitive or inductive proximity sensors. The latter could be used to measure the deformation of the membrane, wherein the symmetry of the bulging may have an impact on the measurement.

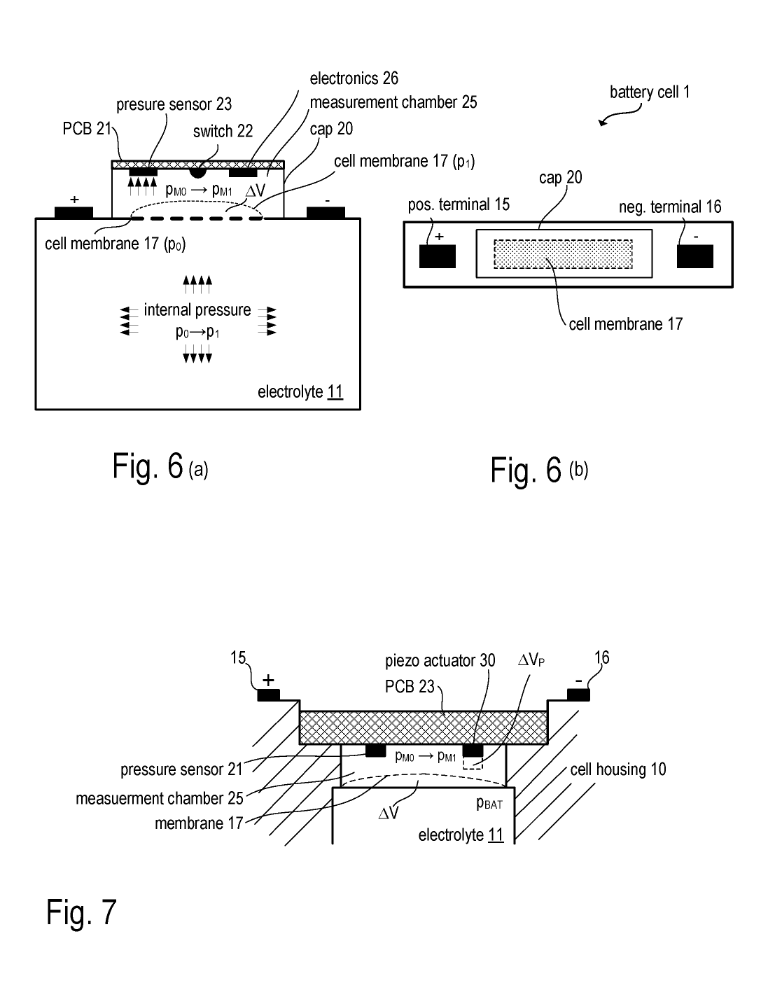

The pressure sensor (see FIG. 4a and FIG. 4b, sensor 21) may be arranged on a PCB, which may be arranged in the measurement chamber or which may be part of the housing that forms the measurement chamber. FIG. 6 illustrates a further example of a battery cell, which has a pressure sensor 21 arranged on a printed circuit board (PCB) 23, which covers the cap 20 so that a sealed measurement chamber 25 is formed in the interior of the cap 20. In the depicted example, the PCB 23 may be regarded as part of the cap 20, wherein the PCB 23 covers housing of the measurement chamber 25. A gasket may be arranged between the PCB 23 and the side walls of the measurement chamber 25 to ensure a gas-tight sealing of the measurement chamber. Further digital and analog electronic components may be arranged on the PCB 23 including electronic circuits (see FIG. 6a and FIG. 6b, electronics 26) for processing the pressure information provided by the pressure sensor 21. However, in other embodiments, the electronics 26 or processing the pressure information may be disposed outside the measurement chamber 25, while the pressure sensor is disposed within the measurement chamber 25.

As a further safety feature a proximity sensor 22 may be provided in the measurement chamber 25, for example, on the PCB 23. In one simple implementation, the proximity sensor may be a mechanical switch that is disposed in the measurement chamber such that the membrane 17 mechanically actuates the switch when bulging of the membrane due to increasing internal pressure p_{BAT} reaches a defined amount. However, any other type of proximity sensor (such as capacitive or inductive proximity sensors) may also be applicable in alternative implementations. Generally, the proximity sensor 22 may be configured to detect, when the bulge of the membrane 17 reaches a defined value. The proximity sensor 22 may trigger a safety mechanism (e.g. a disconnecting the load from the battery) independent from the pressure measurement, which may be regarded as an additional contribution to the function safety of the battery. In some applications such kind of redundancy may be needed to comply with applicable functional safety standards such as ISO26262. The safety mechanism may include initiating one or more safety precautions such as disconnecting the load form the battery.

Dependent on the application, the whole measurement set-up may be provided redundant to increase functional safety. That is, two or more separate measurement chambers may be provided for a single battery cell, wherein each measurement chamber is coupled to the interior of the battery cell by a membrane and equipped with a pressure sensor for measuring the pressure in the respective measurement chamber. Dependent on the application the two or more measurement chambers may be identical or may be designed differently.

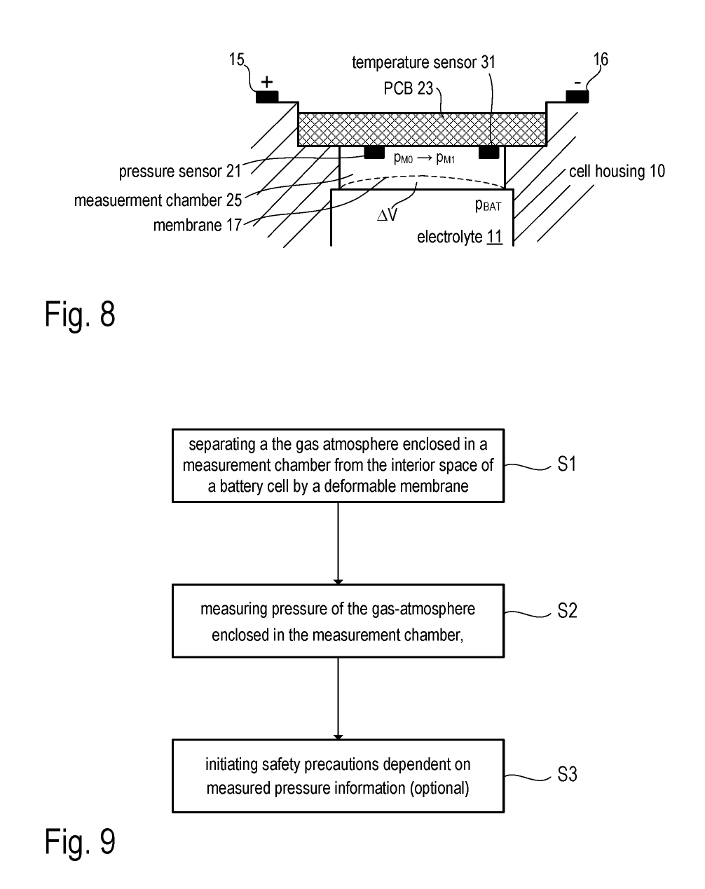

FIG. 7 illustrates another exemplary implementation of a battery cell 1 with a separate measurement chamber 25 for indirect measurement of the internal pressure p_{BAT} in the interior (where the electrolyte 11 resides) of the cell housing 10. In the present example, the measurement chamber 25 is not formed by a cap 20 (as in the previous examples) but rather integrated in the cell housing 10 as shown in FIG. 8. Nevertheless, the measurement chamber 25 is coupled to the interior of the battery cell by the membrane 17. Like in the previous example any pressure change of the internal pressure p_{BAT} is transformed in a respective change of the bulging of membrane 17 and thus in a volume difference ΔV. As previously described the pressure p_{M1} in the measurement chamber 25 depends on the volume difference ΔV and thus indirectly on the internal pressure p_{BAT}. In the present example, the initial volume V_{M0} (see equation 3) may be tuned by disposing an actuator 30 such as, for example, a piezo actuator in the measurement chamber. The actuator 30 can effect an additional volume change ΔV_{P}, and thus the initial or “nominal” volume of the measurement chamber 25 may be tuned by appropriately driving the actuator.

Similar to the example of FIG. 6a and FIG. 6b, a PCB 23 may be used to cover the measurement chamber 25. The PCB 23 may be glued to the housing 10 or fixed otherwise to the housing, whereby the measurement chamber 25 is gas-tightly sealed. Gaskets may be used if necessary for a gas-tight sealing. The pressure sensor 21, the actuator 30 and further electronic components (see, e.g., FIG. 6a and FIG. 6b, electronics 26) may also be mounted on the PCB 23. In the depicted example, the PCB 23 forms the cover of the measurement chamber 25. However, in an alternative embodiment a separate cover may be used, while the PCB 23 is arranged within the measurement chamber 25.

FIG. 8 illustrates another exemplary implementation, which is essentially identical to the previous example of FIG. 7 except that a temperature sensor 31 is disposed in the measurement chamber 25 in addition to pressure sensor 21 and the piezo actuator 30 has been omitted. However, in an alternative embodiment the temperature sensor 31 may be provided in addition to the piezo actuator 30. Measuring temperature of the gas atmosphere in the measurement chamber allows for considering the temperature when calculating the internal battery pressure p_{BAT}. For example, a pressure p_{M1}(T₁) may be measured in the measurement chamber 25 at a measured temperature T₁. The mathematical model of ideal gases (see equations 1 and 2) changes as follows when considering temperature changes:

p_{M1}·(V_{M0}−ΔV)=p_{M0}·V_{M0}+m·R_{S}·(T₁−T₀), (7)

wherein the initial pressure p_{M0} and the initial volume V_{M0} are measured at temperature T₀ (e.g. 25° Celsius) and pressure p_{M1} and Volume V_{M1} (i.e. V_{M0}−ΔV) are measured at temperature T₁.

FIG. 9 is a flow chart illustrating one exemplary method for measuring internal pressure of a battery cell. The internal pressure is the pressure present in an interior space of a battery cell, in which in which a battery electrolyte resides (see, e.g., FIG. 4a and FIG. 4b, battery cell 1, electrolyte 11). The measurement of the internal pressure of the batter cell includes measuring pressure of a gas-atmosphere (see FIG. 9, step S2), which is enclosed by a measurement chamber (see, e.g., FIG. 4a and FIG. 4b, measurement chamber 25), wherein the measurement chamber is separated from the interior space of the battery cell by a deformable membrane (see, e.g., FIG. 4a and FIG. 4b, membrane 17, FIG. 9, step S1). Optionally, as mentioned above, safety precautions may be initiated dependent on the measured pressure information (see FIG. 9, Step S3). Additionally or alternatively to the safety precautions, parameters describing the current state of the battery (e.g. SOH, SOC) may be determined based on the measured pressure information.

Several aspects of the embodiments described herein are summarized below. It is noted, however, that the following summary is not an exhaustive enumeration of features but rather an exemplary selection of features which may be important or advantageous in some applications. According to one embodiment, a battery cell includes an interior space, in which a battery electrolyte resides, and a housing that gas-tightly encloses the interior space. The battery cell further includes a gas-tight sealed measurement chamber, which is separated from the interior space by a deformable membrane, in which a pressure sensor is arranged (see, e.g. FIGS. 4 and 6, pressure sensor 21).

In one embodiment the deformable membrane may be arranged between the interior space of the battery cell and the measurement chamber, wherein the membrane is configured to bulge dependent on a pressure difference between the interior space of the battery cell and the measurement chamber. Thus, the volume available in the measurement chamber depends on the bulging of the membrane. The measurement chamber may include a gas atmosphere including air, nitrogen or an inert gas. Any specific gas or gas mixture may be used to tune the characteristics of the of the measurement arrangement. Generally, the membrane may be configured to transform a pressure variation in the interior space of the battery cell into a pressure variation in the gas atmosphere within the measurement chamber (see, e.g. FIGS. 4a, 4b, 6a and 6b, membrane 17).

In some embodiments a proximity sensor (proximity detector) may be arranged in the measurement chamber such that it is actuated by the deformable membrane when the deformation of the deformable membrane reaches a defined value (see, e.g. FIG. 6a and FIG. 6b, switch 22). The battery cell may include a printed circuit board (PCB), on which the proximity sensor is mounted (see, e.g. FIG. 6a and FIG. 6b, PCB 21), as well as electronic circuitry that is arranged on the PCB and configured to detect whether the deformable membrane actuates the switch. Safety precautions may be triggered when actuation of the proximity sensor is detected. The pressure sensor may also be mounted on a PCB (the same PCB on which the proximity sensor is mounted or another PCB). Electronic circuitry may be provided to process pressure information provided by the pressure sensor. The PCB(s) may be arranged within the measurement chamber. Alternatively, the PCB may be part of the housing (see, e.g., FIG. 4a and FIG. 4b, cap 22) enclosing the measurement chamber.

In some embodiments a temperature sensor may be disposed in the measurement chamber for measuring the temperature of the gas atmosphere enclosed by the measurement chamber. Together with pressure information (e.g., pressure p_{M1}) provided by the pressure sensor the temperature information (e.g. temperature T₁) provided by the temperature sensor may be processed (e.g. by a signal processor, a micro, controller, or any other digital or analog circuitry) to obtain a value representing the internal pressure p_{BAT} in the interior space of the battery cell. However, the temperature need not be considered in applications, in which the temperature does not change significantly. Additionally or alternatively, at least one parameter of the battery cell (such as, for example, state of health (SOH) and/or state of charge (SOC)) may be determined based on the measured pressure of the gas-atmosphere enclosed in the measurement chamber.

In some embodiments an actuator may be provided that is configured to tune the volume of the measurement chamber. For example, such an actuator may be a piezoelectric actuator, which changes its volume dependent on a drive voltage applied to the actuator. When used together with a temperature measurement as mentioned above, the actuator may be driven such that the effect of a temperature change is substantially compensated.

Although the invention has been illustrated and described with respect to one or more implementations, alterations and/or modifications may be made to the illustrated examples without departing from the spirit and scope of the appended claims. In particular regard to the various functions performed by the above described components or structures (units, assemblies, devices, circuits, systems, etc.), the terms (including a reference to a “means”) used to describe such components are intended to correspond—unless otherwise indicated—to any component or structure, which performs the specified function of the described component (e.g., that is functionally equivalent), even though not structurally equivalent to the disclosed structure, which performs the function in the herein illustrated exemplary implementations of the invention.

In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”.

The following examples demonstrate one or more aspects of this disclosure and may be combined in any way:

Example 1. A battery cell comprising:

an interior space, in which a battery electrolyte resides;

a housing (10) enclosing the interior space gas-tightly;

a gas-tight sealed measurement chamber (25), which is separated from the interior space by a deformable membrane (17); and

a pressure sensor (21) arranged in the measurement chamber (25).

Example 2 The battery cell of example 1,

wherein the deformable membrane (17) is arranged between the interior space of the battery cell and the measurement chamber (25), the membrane being configured to bulge dependent on a pressure difference between the interior space of the battery cell and the measurement chamber, and the volume available in the measurement chamber depending on the bulging of the membrane.

Example 3. The battery cell of any of examples 1-2 or combinations thereof,

wherein the measurement chamber (25) includes a gas atmosphere.

Example 4. The battery cell of claim any of examples 1-3 or combinations thereof,

wherein the gas atmosphere includes at least one of: air, nitrogen, inert gas.

Example 5. The battery cell of any of examples 1-4 or combinations thereof,

wherein the membrane is configured to transform a pressure variation in the interior space into a pressure variation in the gas atmosphere within the measurement chamber.

Example 6. The battery cell of any of examples 1-5 or combinations thereof, further comprising:

a proximity sensor arranged in the measurement chamber such that it is actuated by the deformable membrane when the deformation of the deformable membrane reaches a defined value.

Example 7. The battery cell of any of examples 1-6 or combinations thereof, wherein the proximity sensor is a mechanical switch arranged such that it is actuated when, due to bulging of the deformable membrane, the membrane touches the switch.

Example 8. The battery cell of any of examples 1-7 or combinations thereof, further comprising:

a printed circuit board (PCB), on which the mechanical switch sensor is mounted;

electronic circuitry arranged on the PCB and configured to detect whether the deformable membrane actuates the mechanical switch and to trigger safety precautions when actuation of the mechanical switch is detected.

Example 9. The battery cell of any of examples 1-8 or combinations thereof, further comprising:

a printed circuit board (PCB), on which the pressure sensor is mounted;

electronic circuitry arranged on the PCB and configured to process pressure information provided by the pressure sensor.

Example 10. The battery cell of example 8 or 9 or any of examples 1-9 or combinations thereof,

wherein the PCB is arranged within the measurement chamber or wherein the PCB is part of the housing enclosing the measurement chamber.

Example 11. The battery cell of any of examples 1-10 or combinations thereof, further comprising:

a temperature sensor arranged within the measurement chamber to measure the temperature of a gas atmosphere within the measurement chamber.

Example 12. The battery cell of any of examples 1-11 or combinations thereof, further comprising:

electronic circuitry configured to process pressure information provided by the pressure sensor and temperature information provided by the temperature sensor to obtain a value representing the internal pressure in the interior space of the battery cell.

Example 13. The battery cell of any of examples 1-12 or combinations thereof, further comprising:

an actuator configured to tune a volume enclosed in the measurement chamber.

Example 14. The battery cell of example 13,

wherein the actuator is a piezo actuator, which changes its volume dependent on a drive voltage applied to the actuator.

Example 15. A method for measuring internal pressure in an interior space of a battery cell, in which in which a battery electrolyte resides, the method comprising:

measuring pressure of a gas-atmosphere enclosed in a measurement chamber, the measurement chamber being separated from the interior space of the batter cell by a deformable membrane.

Example 16, The method of example 15,

wherein the membrane transforms a pressure variation in the interior space into a pressure variation in the gas atmosphere enclosed in the measurement chamber.

Example 17. The method of any of examples 14-16 or combinations thereof,

wherein the deformable membrane bulges dependent on a pressure difference between the interior space of the battery cell and the measurement chamber, the volume available in the measurement chamber thus depending on the bulging of the membrane.

Example 18. The method of any of examples 14-17 or combinations thereof, further comprising:

triggering, by the membrane, a proximity sensor arranged in the measurement chamber, when the deformation of the deformable membrane reaches a defined value.

Example 19. The method of any of examples 14-18 or combinations thereof, further comprising:

initiating safety precautions dependent on measured pressure information.

Example 20. The method of any of examples 14-19 or combinations thereof, further comprising:

measuring temperature of the gas atmosphere enclosed in the measurement chamber.

Example 21. The method of any of examples 14-20 or combinations thereof, further comprising:

calculating an internal pressure in the interior space of the battery cell based on the measured pressure of the gas-atmosphere enclosed in the measurement chamber and the measured temperature.

Example 22. The method of any of examples 14-21 or combinations thereof, further comprising:

calculating an internal pressure in the interior space of the battery cell based on the measured pressure of the gas-atmosphere enclosed in the measurement chamber.

Example 23. The method of any of examples 14-22 or combinations thereof, further comprising:

determining the state of the membrane based on the measured pressure of the gas-atmosphere enclosed in the measurement chamber,

wherein the state of the membrane is one of: elastic strain, plastic, and ultimate tensile strength reached.

Example 24. The method of any of examples 14-23 or combinations thereof, further comprising:

determining at least one parameter of the battery cell based on the measured pressure of the gas-atmosphere enclosed in the measurement chamber,

wherein at least one parameter is one of: state of health (SOH) and state of charge (SOC).

We claim:

1. A battery cell comprising:
an interior space, in which a battery electrolyte resides;
a housing enclosing the interior space gas-tightly;
a gas-tight sealed measurement chamber, which is separated from the interior space by a deformable membrane; and
a pressure sensor arranged in the measurement chamber.

2. The battery cell of claim 1,
wherein the deformable membrane is arranged between the interior space of the battery cell and the measurement chamber, the membrane being configured to bulge dependent on a pressure difference between the interior space of the battery cell and the measurement chamber, and the volume available in the measurement chamber depending on the bulging of the membrane.

3. The battery cell of claim 1,
wherein the measurement chamber includes a gas atmosphere.

4. The battery cell of claim 3,
wherein the gas atmosphere includes at least one of: air, nitrogen, inert gas.

5. The battery cell of claim 3,
wherein the membrane is configured to transform a pressure variation in the interior space into a pressure variation in the gas atmosphere within the measurement chamber.

6. The battery cell of claim 1 further comprising:
a proximity sensor arranged in the measurement chamber such that it is actuated by the deformable membrane when the deformation of the deformable membrane reaches a defined value.

7. The battery cell of claim 6, wherein the proximity sensor is a mechanical switch arranged such that it is actuated when, due to bulging of the deformable membrane, the membrane touches the switch.

8. The battery cell of claim 6 further comprising:
a printed circuit board (PCB), on which the mechanical switch sensor is mounted;
electronic circuitry arranged on the PCB and configured to detect whether the deformable membrane actuates the mechanical switch and to trigger safety precautions when actuation of the mechanical switch is detected.

9. The battery cell of claim 1 further comprising:
a printed circuit board (PCB), on which the pressure sensor is mounted;
electronic circuitry arranged on the PCB and configured to process pressure information provided by the pressure sensor.

10. The battery cell of claim 8,
wherein the PCB is arranged within the measurement chamber or wherein the PCB is part of the housing enclosing the measurement chamber.

11. The battery cell of claim 1 further comprising:
a temperature sensor arranged within the measurement chamber to measure the temperature of a gas atmosphere within the measurement chamber.

12. The battery cell of claim 11 further comprising:
electronic circuitry configured to process pressure information provided by the pressure sensor and temperature information provided by the temperature sensor to obtain a value representing the internal pressure in the interior space of the battery cell.

13. The battery cell of claim 1 further comprising:
an actuator configured to tune a volume enclosed in the measurement chamber.

14. The battery cell of claim 13,
wherein the actuator is a piezo actuator, which changes its volume dependent on a drive voltage applied to the actuator.

15. A method for measuring internal pressure in an interior space of a battery cell, in which in which a battery electrolyte resides, the method comprising:
measuring pressure of a gas-atmosphere enclosed in a measurement chamber, the measurement chamber being separated from the interior space of the batter cell by a deformable membrane.

16. The method of claim 15,
wherein the membrane transforms a pressure variation in the interior space into a pressure variation in the gas atmosphere enclosed in the measurement chamber.

17. The method of claim 15,
wherein the deformable membrane bulges dependent on a pressure difference between the interior space of the battery cell and the measurement chamber, the volume available in the measurement chamber thus depending on the bulging of the membrane.

18. The method of claim 15, further comprising:
triggering, by the membrane, a proximity sensor arranged in the measurement chamber, when the deformation of the deformable membrane reaches a defined value.

19. The method of claim 15, further comprising:
initiating safety precautions dependent on measured pressure information.

20. The method of claim 15 further comprising:
measuring temperature of the gas atmosphere enclosed in the measurement chamber.

21. The method of claim 16 further comprising:
calculating an internal pressure in the interior space of the battery cell based on the measured pressure of the gas-atmosphere enclosed in the measurement chamber and the measured temperature.

22. The method of claim 15 further comprising:
calculating an internal pressure in the interior space of the battery cell based on the measured pressure of the gas-atmosphere enclosed in the measurement chamber.

23. The method of claim 15 further comprising:
determining the state of the membrane based on the measured pressure of the gas-atmosphere enclosed in the measurement chamber,
wherein the state of the membrane is one of: elastic strain, plastic, and ultimate tensile strength reached.

24. The method of claim 15 further comprising:
determining at least one parameter of the battery cell based on the measured pressure of the gas-atmosphere enclosed in the measurement chamber,
wherein at least one parameter is one of: state of health (SOH) and state of charge (SOC).
